(19) United States
(12) Patent Application Publication
(10) Pub. No.: US 2007/0075844 A1
(43) Pub. Date: Apr. 5, 2007

(54) Alarm apparatus

(76) Inventor: John F. Taylor, Ortonville, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/243,238

(22) Filed: Oct. 4, 2005

(51) Int. Cl. G08B 3/00

(52) U.S. Cl. 340/384.1

(57) ABSTRACT

An alarm apparatus may include a housing constructed of a base and a lens. A control apparatus, a light and a siren may positioned within the housing. An external sensor may also be provided to monitor an environment and trigger the alarm. The control apparatus is operable to permit a user to select a particular arrangement of light flashes, siren tones and siren volumes. Accordingly, the same type of alarm apparatus may be used in connection with many different types of sensors since a different alert arrangement could be select for each alarm apparatus. Furthermore, alarm apparatus having different alert arrangements could be used with the same type of sensors to give an indication of the location of the alarm within a facility.

### BACKGROUND OF THE INVENTION

1. Field of the Invention

The present invention concerns an alarm apparatus. More specifically, the invention concerns an alarm apparatus usable with an external sensor that permits selection of a variety of alarm signals such that the same type of alarm apparatus may emit an alarm signal comprising different patterns of light and sound depending on the need of the user.

2. Reference to Related Art

The art includes alarm systems that include audio and visual alerts. For example, U.S. Pat. No. 5,132,659 issued Jul. 21, 1992 to Kuo disclosed a flashing light siren alarm. Specifically, Kuo described an alarm system that included a flashing strobe light and a siren. A battery is provided to provide power to the light and siren during use. Further, the convex plate is positioned in front of the siren to radially deflect an alert emitted from the siren away from the alarm housing.

Another reference is U.S. Pat. No. 6,144,309, which issued Nov. 7, 2000 to Fagence. This reference disclosed an alarm device with audio and visual indicators positioned in flameproof housing. Specifically, a siren is positioned at one end of the housing and a strobe at an opposite end of the housing. A dome is positioned above the siren to radially deflect an alert emitted by the siren. The housing is constructed to contain any flames that may result from an explosion of the unit. Further, a circuit board is included that has a control switch for the siren or the strobe. Using the switch, the siren can emit different sounds or frequency of sounds to give an alert that a toxic gas is present, or to give a general alarm.

### SUMMARY OF THE INVENTION

An alarm apparatus may include a housing constructed of a base and a lens that is positioned on or otherwise fitted to the base. A control apparatus in the form of a circuit board may positioned on the base. A light and a siren may be provided and are positioned on the base or the circuit board and operate to communicate with the circuit board.

The control apparatus may include toggle switches that are positioned on the circuit board and permit selection of the tone or volume of the siren or a flash pattern for light.

The apparatus may be in communication with a sensor that monitors an environment and, if necessary, triggers the apparatus. The sensor may include most any sensor system including, but not limited to, a sensor for detecting smoke, fire, carbon-monoxide, radon, improper entry, movement, heat and pressure.

Accordingly, the same type of alarm apparatus may be used in connection with many different types of sensors since a different alert arrangement could be selected for each alarm apparatus. Furthermore, alarm apparatus having different alert arrangements could be used with the same type of sensors to give an indication of the location of the alarm within a facility.

### BRIEF DESCRIPTION OF THE DRAWINGS

Reference will now be made to the attached drawings wherein like reference numerals refer to like parts throughout and wherein:

FIG. 1 is an environmental perspective view showing an embodiment of an alarm apparatus mounted to a surface;

FIG. 2 is a perspective view of an embodiment of an alarm apparatus wherein the lens is shown in phantom and the interior of the apparatus is visible;

FIG. 3 is a partial perspective view of the toggle switch array for control of an alarm light;

FIG. 4 is a partial perspective view of a toggle switch arrangement for control of the siren alarm tone;

FIG. 5 is a partial perspective view of a terminal strip;

FIG. 6 is a table view of the toggle switch arrangement for controlling the timing of and volume of the siren and timing of the light;

FIG. 7 is a rear perspective view of an embodiment of an alarm apparatus;

FIG. 8 is a side view of an embodiment of an alarm apparatus;

FIG. 9 is a partial perspective view of the tamper switch shown in FIG. 8; and

FIG. 10 is a circuit diagram of the electronics for an embodiment of the alarm apparatus.

### DETAILED DESCRIPTION

Referring now to FIGS. 1, 2 and 7-9, an alarm apparatus 10 may include a housing 12 that has a base 14 and a lens 16 positioned on the base 14. A control apparatus 18, that may include a circuit board 20, is positioned in an interior of the housing 12. A light 22 and a siren 24 may be positioned on the base 14 and communicate with the control apparatus 18. The control apparatus 18 may permit selective setting of the tone or volume of the siren 24 and a flash pattern for light 22. The control apparatus 18 may also be in communication with a sensor 26 that may monitor an environment or condition and, if necessary, activate the apparatus 10. The sensor 26 may include most any sensor system including, but not limited to, a sensor for detecting smoke, heat (fire), carbon-monoxide, radon, improper entry, movement and pressure.

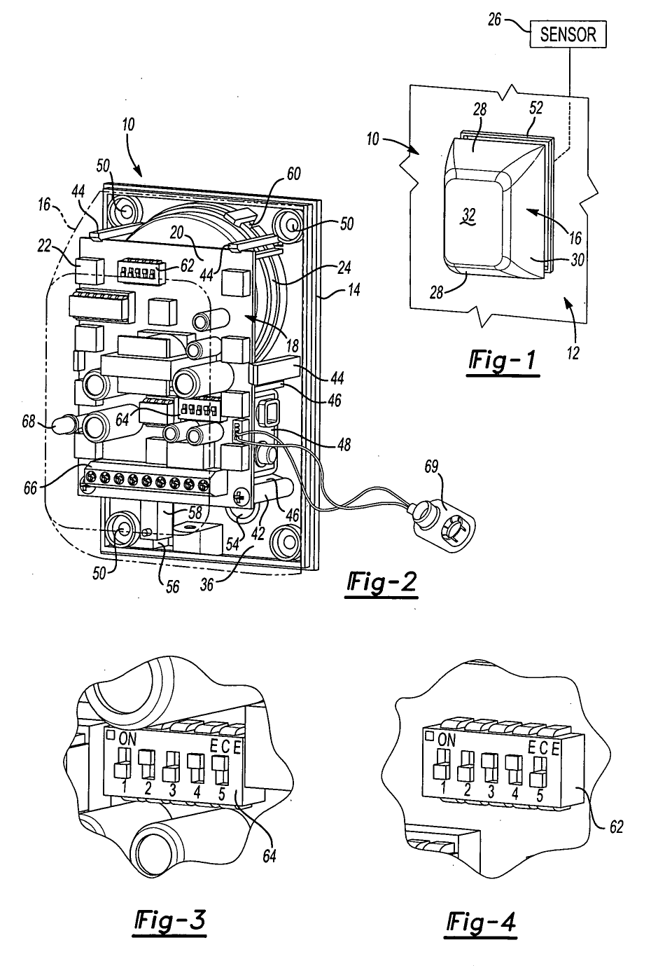

Referring now to FIGS. 1 and 2, an embodiment of the housing 12 of the apparatus 10 may have a polycarbonate construction with a flammability rating of UL94V-2. However, the housing 12, particularly the base 14, may be constructed using different materials (e.g., aluminum, steel, stainless steel, carbon fiber, or Plexiglas) according to the needs of the user. The housing 12 may also have dimension in the range of a width of 83 mm, a length of 123 mm and a height of 69 mm.

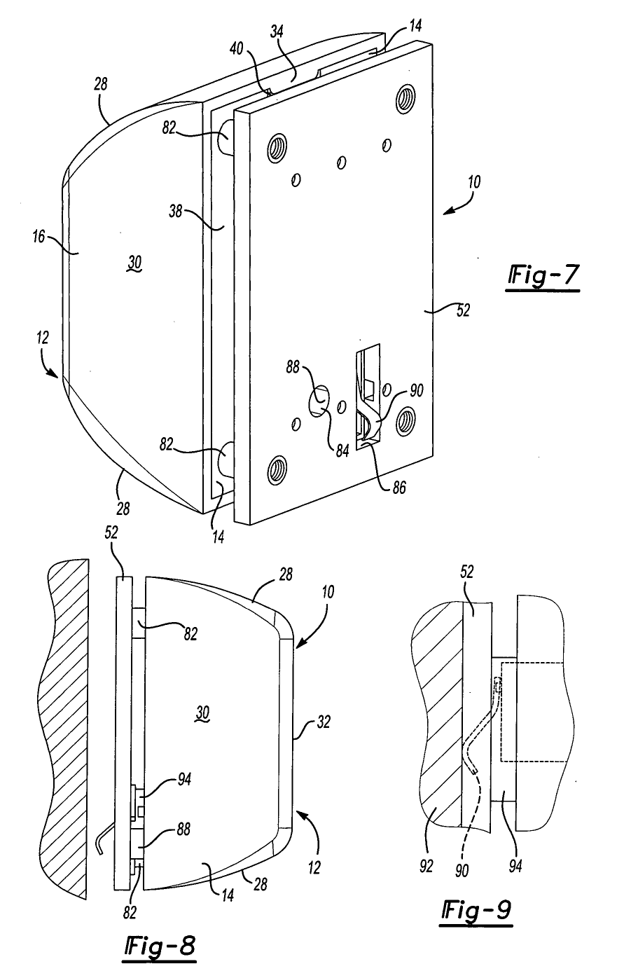

Still referring now to FIGS. 1, 2 and 7, the lens 16 may be formed as a transparent or colored (e.g., amber, blue, green, red or white) polycarbonate structure having a pair of tapered end walls 28, pair of tapered sidewalls 30 and a generally flat top surface 32. A series of grooves (not shown) may be provided on the interior (not shown) of the lens 16 to diffuse any transmission by the light 22. As best shown in FIG. 7, one end wall 28 of the lens 16 may include a lip 34 or flange that may engage the base 14 as described below.

Referring now to FIGS. 2 and 7, the base 14 may include a generally rectangular shape having a front 36 and rear 38 face (although other shapes e.g., circular or oval, may be used). As shown in FIG. 7, the rear face 38 includes a groove 40 that may be engaged by the lip 34 of the lens 16 to assist in mounting the lens 16 to the base 14. As best shown in FIG. 2, the circuit board 20 may be secured to posts 42 that extend from the front face 36 such that the circuit board 20 is spaced a distance above the front face 36. A plurality of clips 44 that extend from the front face 36 may also be provided to further engage and fix the circuit board 18 in position above the base 14.

Referring to FIG. 2, a pair of spaced apart walls 46 may extend from the front face 36 to form a channel for retaining a temporary power source 48 such as a 9V battery. A plurality of mounting apertures 50 may be defined through the base 14 for use in securing the base 14 to a mounting plate 52 (discussed below). The base 14 may feature apertures 54, 56 for use, respectively, in the threading of external wiring (not shown) into the housing 12 and for the extension of a tamper switch 58 (discussed below). Finally, an aperture 60 may be defined in the base 14 for use in positioning (as will be discussed below) the siren 24.

Still referring to FIGS. 1 and 10, the siren 24 may be positioned on the front face 36 of the base 14 below the circuit board 20. Insulation (not shown) may also be provided between the siren 24 and the circuit board 20 to prevent damage to either part. A speaker (not shown) of the siren 24 may extend through the aperture 60 of the base 14 such that the front (not shown) of the speaker (not shown) is generally flush with the rear face 38 of the base 14. The siren 24 may operate to emit an alert in a range between 85 to 100 db. However, the apparatus 10 may be constructed to include a siren 24 having a greater or lesser range of sound emission.

Referring now to FIGS. 2-5 and 10, the circuit board 20 of the control apparatus 18 may include the light 22, an alarm tone switch 62, a timing and volume switch 64, a terminal strip 66, low battery indicator light 68 and a battery cable 70. It will be appreciated that the battery cable 69 functions to connect the temporary power source 48 to the control apparatus 18 and that the low battery indicator light 68 activates following an indication from the control apparatus that the life temporary power source 48 will soon terminate.

As best shown in FIG. 2, the light 22 may include one or more LEDs. For example, the light 22 may include an array of ten LEDs. However, a greater or fewer number of LEDs may be used in the present invention. Furthermore, the light 22 may include other manner of lights such as chemical, fluorescent or incandescent lights.

Referring now to FIGS. 2, 4 and 10, the control apparatus 18 may further include an alarm tone switch 62 and a timing and volume switch 64. The alarm tone switch 62 may be used to control the character of the sound alert emitted by the siren 24. Specifically, as shown, the switch 62 is set to emit an alert that is “steady fast”. However, other tones may also be selected to be used, at least as set forth on the following table.

| | SWITCH | | | | | |
|---|---|---|---|---|---|---|
| | (42) | | | | | |
| TONE | SETTING | | | | | |
| NUMBER | 1 | 2 | 3 | 4 | 5 | TONE |
| 1 | 0 | 0 | 0 | 0 | 0 | BUZZ |
| 2 | 1 | 0 | 0 | 0 | 0 | SLOW ON/OFF |
| 3 | 0 | 1 | 0 | 0 | 0 | SLOW SIREN |
| 4 | 1 | 1 | 0 | 0 | 0 | 3 BEEP/PAUSE/REPEAT |
| 5 | 0 | 0 | 1 | 0 | 0 | UFO FAST |
| 6 | 1 | 0 | 1 | 0 | 0 | FAST SIREN |
| 7 | 0 | 1 | 1 | 0 | 0 | # 5 FAST |
| 8 | 1 | 1 | 1 | 0 | 0 | # 2 MEDIUM |
| 9 | 0 | 0 | 0 | 1 | 0 | # 5 MEDIUM |
| 10 | 1 | 0 | 0 | 1 | 0 | SWOOP MEDIUM |
| 11 | 0 | 1 | 0 | 1 | 0 | #3 MEDIUM |
| 12 | 1 | 1 | 0 | 1 | 0 | BUZZ TONE |
| 13 | 0 | 0 | 1 | 1 | 0 | STEADY FAST |
| 14 | 1 | 0 | 1 | 1 | 0 | SWOOP SLOW |
| 15 | 0 | 1 | 1 | 1 | 0 | CONTINOUS |
| 16 | 1 | 1 | 1 | 1 | 0 | FAST REPEAT |
| 17 | 0 | 0 | 0 | 0 | 1 | STANDARD ALARM |
| 18 | 1 | 0 | 0 | 0 | 1 | # 3 FAST |
| 19 | 0 | 1 | 0 | 0 | 1 | # 5 SLOW |
| 20 | 1 | 1 | 0 | 0 | 1 | FAST BEEP |
| 21 | 0 | 0 | 1 | 0 | 1 | SOUND A |
| 22 | 1 | 0 | 1 | 0 | 1 | SOUND B |
| 23 | 0 | 1 | 1 | 0 | 1 | SOUND C |
| 24 | 1 | 1 | 1 | 0 | 1 | SOUND D |
| 25 | 0 | 0 | 0 | 1 | 1 | SOUND D LOUD |
| 26 | 1 | 0 | 0 | 1 | 1 | SOUND E |
| 27 | 0 | 1 | 0 | 1 | 1 | SOUND F |
| 28 | 1 | 1 | 0 | 1 | 1 | SOUND G |
| 29 | 0 | 0 | 1 | 1 | 1 | SOUND H |
| 30 | 1 | 0 | 1 | 1 | 1 | # 4 LOW |
| 31 | 0 | 1 | 1 | 1 | 1 | SOUND K |
| 32 | 1 | 1 | 1 | 1 | 1 | CONTINUOUS FAST |

As shown, the switch 62 is a toggle switch in the form of a five-throw dip switch. However, other manner of switches or programmable memory may also be used to construct the switch 62.

Referring now to FIGS. 2, 3 and 10, and as best shown in FIG. 6, the timing and volume switch 64 may be used to control the timing of an signal emitted by the siren 22, the timing of the flash for the light 22 and the volume of the signal emitted by the siren 24. For example, as shown in FIG. 3, the switch 64 is set such that the apparatus 10, if activated, would emit a 60 second alert at a high volume with a sixty-second flash pattern. As shown, the switch 64 is a toggle switch in the form is a five-throw dip switch. However, other manner of switches or programmable memory may also be used to construct the switch 64.

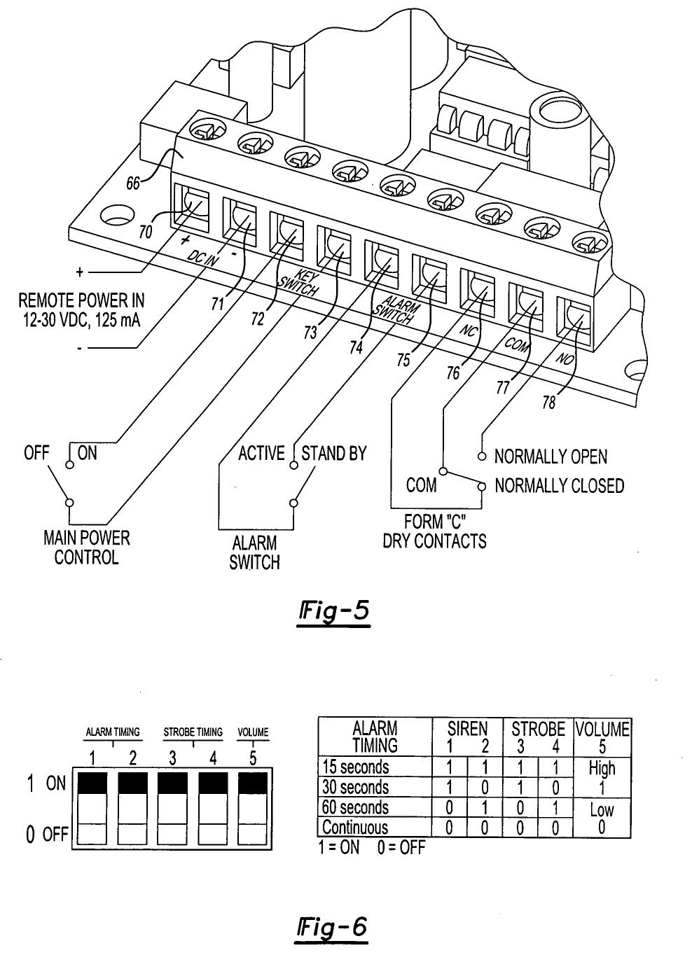

Referring now to FIGS. 2 and 5, the terminal strip 66 has an array of terminals including DC connection terminals 70, 71 for connecting a remote power source. Therefore, it will be appreciated that the apparatus 10 may be directly connected to an external permanent power supply (e.g., a facility power supply) in addition to the use of the temporary power source 48. Still other terminals may include a key switch terminal 72, 73, an alarm switch terminal 74, 75, a normally closed terminal 76, a COM terminal 78 and a normally open terminal 80. Any external wiring for the apparatus 10 may be threaded into the housing 12 through the aperture 54 defined in the base 14.

As best shown in FIGS. 1, 2, 7 and 8 and as mentioned above, mounting apertures 50 are positioned in each of the corners of the base 14 such that the base 14 may be secured to a mounting plate 52. Specifically, as best shown in FIGS. 7 and 8, the mounting plate 52 includes a plurality of legs 82 that may be aligned with and fitted (through the use of fasteners or the like) to the base 14 at the mounting apertures 50. The mounting plate 52 is spaced a predetermined distance from the base 14 such any alert emitted by the siren 22 is deflected off the mounting plate 52 and into the environment. As an alternative to the mounting plate 52, the housing 12 may also be secured to a key switch lock mounting bracket (not shown), an electrical back box (not shown), a single gang electrical box (not shown) or other similar structures. The mounting plate 52 may include apertures 84, 86 that may be aligned, respectively, with the apertures 54, 56 of the base 14. A generally circular wall 88 may extend from the mounting plate 52 around the aperture 84 to enclose the space between the aperture 54 of the base 14 and the aperture 84 of the mounting plate 52 such that wires (not shown) may be threaded though the mounting plate 52 and the base 14 and into the housing 12 without being exposed to the environment.

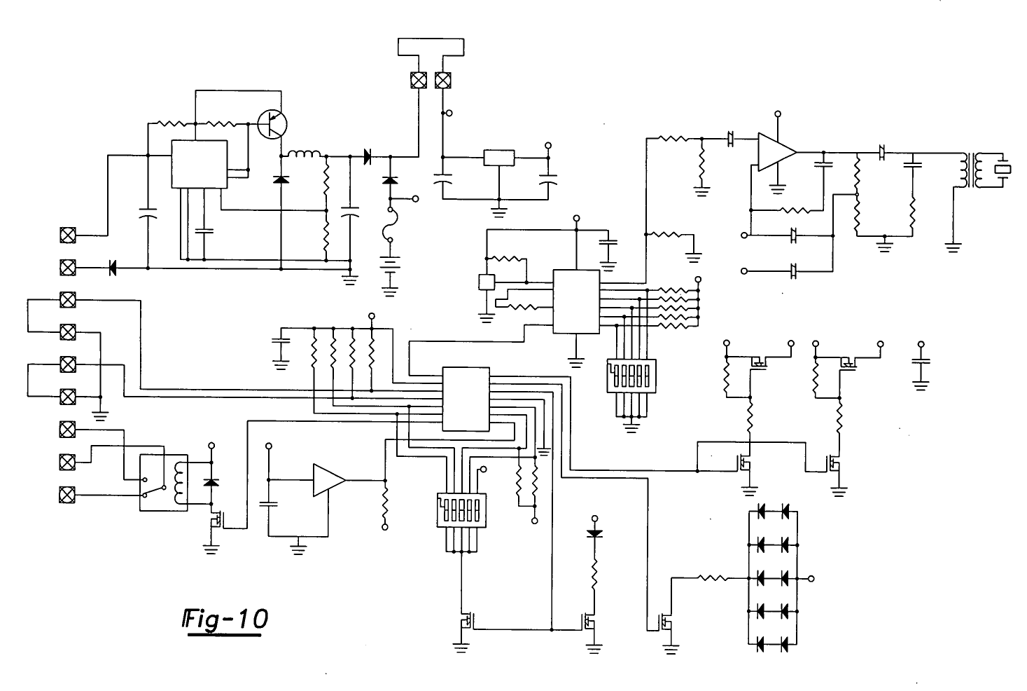

Referring now to FIGS. 2 and 7-9, the tamper switch 58 operates to activate apparatus 10 when housing 12 has been removed from an installed position. The tamper switch 58 may be positioned on the base 14 and include an arm 90 that extends through the apertures 56, 86, respectively, of the base 14 and mounting plate 52. For example, as best shown in FIGS. 7-9, the arm 90 of the tamper switch 58 engages a surface 92 upon which the housing 12 may be mounted. The removal of the housing 12 from the surface 92 results in the extension of the arm 90, activation of the switch 58 and thus the apparatus 10. As best shown in FIGS. 8 and 9, a wall 94 may extend from the mounting plate 52 around the aperture 86 to enclose the space between the aperture 55 of the base 14 and the aperture 86 of the mounting plate 62 so that the tamper switch 58 is not exposed to the environment.

Having thus described my invention, various other embodiments will become known to those of skill in the art that do not depart from the spirit of the present invention.

I claim:

1. An alarm apparatus comprising:
a housing including a base and a lens positioned on the base, a control apparatus positioned within the housing, a light and a siren in communication with the control apparatus, the control apparatus being operable to permit selection of one of a plurality of tone and volumes settings for the siren and one of a plurality of flash patterns for light.

2. The alarm apparatus of claim 1, wherein the control apparatus further comprises a circuit board and a first and a second toggle switch positioned on the circuit board, the first toggle switch be operable to select the tone for the siren and the second toggle switch being operable to control the timing and volume of tone for the siren and the timing of the flash pattern for the light.

3. The alarm apparatus of claim 1, wherein the siren further comprises a speaker operable to emit sound signal in a range between 85 to 100 decibels.

4. The alarm apparatus of claim 1, further comprising a temporary power source.

5. The alarm apparatus of claim 1, wherein the temporary power source comprises a 9 volt battery.

6. The alarm apparatus of claim 1, further comprising a terminal strip positioned on the control apparatus.

7. The alarm apparatus of claim 1, further comprising a tamper switch in communication with the control apparatus.

8. The alarm apparatus of claim 1, further comprising a mounting plate secured to and spaced a predetermined distance from the base.

9. The alarm apparatus of claim 1, wherein the base includes a surface having a front face and a rear face and that defines an aperture and the siren being positioned on the front face of the base and extending through the aperture to the rear face.

10. The alarm apparatus of claim 1, further comprising a sensor in communication with the control apparatus.

11. The alarm system of claim 10, wherein the sensor is selected from a group consisting of a smoke sensor, a heat sensor, a carbon-monoxide sensor, a radon sensor, an entry sensor, a movement sensor and a pressure sensor.

12. A alarm system comprising:
a sensor; and
an alarm apparatus in communication with the sensor, the alarm apparatus including a housing having a base and a lens positioned on the base, a control apparatus positioned within the housing and a light and a siren in communication with the control apparatus, the control apparatus being operable to permit selection of one of a plurality of tone and volumes settings for the siren and one of a plurality of flash patterns for light.

13. The alarm apparatus of claim 12, wherein the control apparatus further comprises a circuit board and a first and a second toggle switch positioned on the circuit board, the first toggle switch being operable to select the tone for the siren and the second toggle switch being operable to control the timing and volume of tone for the siren and the timing of the flash pattern for the light.

14. The alarm apparatus of claim 12, wherein the siren further comprises a speaker operable to emit sound signal in a range between 85 to 100 decibels.

15. The alarm apparatus of claim 12, further comprising a temporary power source.

16. The alarm apparatus of claim 12, wherein the temporary power source comprises a 9 volt battery.

17. The alarm apparatus of claim 12, further comprising a terminal strip positioned on the control apparatus.

18. The alarm apparatus of claim 12, further comprising a tamper switch in communication with the control apparatus.

19. The alarm apparatus of claim 12, further comprising a mounting plate secured to and spaced a predetermined distance from the base.

20. The alarm apparatus of claim 12, wherein the base includes a surface having a front face and a rear face and that defines an aperture and the siren being positioned on the front face of the base and extending through the aperture to the rear face.
